(19) United States
(12) Patent Application Publication
(10) Pub. No.: US 2010/0218261 A1
(43) Pub. Date: Aug. 26, 2010

(54) ISOLATING PROCESSES USING ASPECTS

(76) Inventor: James P. Schneider, Raleigh, NC (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/393,992

(22) Filed: Feb. 26, 2009

(51) Int. Cl. G06F 21/00

(52) U.S. Cl. 726/27

(57) ABSTRACT

A system and method for receiving a request to load a computer application into a memory for execution, analyzing the computer application to identify one or more join points, injecting aspect computer code into the computer application at the one or more join points, wherein the aspect computer code to regulate the execution of restricted operations initiated by the computer application based on a restricted operations profile associated with the aspect computer code, and executing the computer application having the aspect computer code injected therein.

### TECHNICAL FIELD

Embodiments of the invention relate to the field of computer processing, and more particularly, to isolating processes executing within a computer.

### BACKGROUND

As computer processing technology became increasingly popular, the need for enhanced security of computing resources increased. The vast availability of computing platforms and technologies have created opportunities for computer hackers to surreptitiously gain access to the computing resources belonging to unsuspecting individuals and use those computing resources to carry out anything from mischievous pranks to crippling Denial of Service (DoS) attacks, to widespread financial fraud.

A longstanding protection used against such unauthorized access to a computing device or its corresponding resources is through the use of Network protections. Network protections such as Firewalls, proxy servers, and intelligent network gateways and routers protect computer resources on a network by, generally speaking, denying access to any computer which makes unsolicited requests for resources from a protected device, or attempts to execute commands or send information to the protected device without prior approval.

Unfortunately, network protections cannot protect against all mechanisms by which modern computer hackers attempt to gain unauthorized access to computing resources. For example, computer hackers may attempt to gain unauthorized access to a computing resource or to information within a computing device by tricking an unsuspecting victim into executing computer code locally that, for example, accesses protected memory areas belonging to unrelated processes, modifies a portion of another executing program image in memory, writes malicious or unauthorized code to an area of memory and then marks that writable area as executable, or causes programs and processes on the computing device to dynamically load executable code not originally intended for execution.

Such computer code when loaded, modified, or written into memory in such a way can be made to carry out any manner of malicious or unauthorized tasks, such as secretly authorizing remote network access to the computing device, sending sensitive data to a remote location, or opening a hidden gateway for a remote computing device to execute commands locally at the unsuspecting computer host.

Traditional mechanisms that exist for ensuring computer code is “trusted” or otherwise safe to execute on a local machine are, unfortunately, too time consuming and costly for generally available consumer applications. A hands-on extensive examination of the subject code is required to seek out any bugs or malicious code that could violate the intended security precautions, and only after such an examination is completed, is an executable image of the computer code certified as “trusted” for a particular application. While such a process is common place in mission critical Enterprise applications and very high security environments, this process is simply not feasible for a vast number of general utility computer applications.

Other mechanisms which have been proposed include modifying existing applications to self-certify that they do not, for example, modify memory portions allocated to other processes, attempt to modify the executing code of other processes, or attempt to cause other images, or themselves, to dynamically load malicious code segments for execution. Unfortunately, such a proposed mechanism is easily overcome by any computer programmer who either negligently or maliciously fails to adhere to the stated program requirements.

Another proposed mechanism includes rewriting a host operating system in conjunction with re-written executable applications which must adhere to certain requirements, such as not attempting to modify or access memory allocated to other processes, and then having those requirements checked and enforced by the operating system itself. While such a mechanism is more difficult to overcome, an extensive amount of effort must be invested in upgrading and updating so called, “legacy” applications, which are often unsupported, in order to make those applications execute within an operating system that enforces such programming requirements. Even computer applications which enjoy current support, would require much wasted effort to make the applications compatible with the new requirements. Such a solution is thus impractical for many computer applications.

There are a great many applications which would therefore, be rendered obsolete, or incompatible with a new operating system having the more strict security requirements which prohibit certain types of memory access or modification of executing code.

### BRIEF DESCRIPTION OF THE DRAWINGS

The present invention is illustrated by way of example, and not by way of limitation, and can be more fully understood with reference to the following detailed description when considered in connection with the figures in which:

FIG. 1 illustrates an exemplary network architecture in which embodiments of the present invention may operate;

FIG. 2 is a diagrammatic representation of a computing device in accordance with one embodiment of the present invention;

FIG. 3 is a flow diagram illustrating a method for injecting aspect computer code into a computer application to regulate execution of restricted operations, in accordance with one embodiment of the present invention;

FIG. 4 is a flow diagram illustrating a method for executing a computer application having aspect computer code injected therein, in accordance with one embodiment of the present invention; and

FIG. 5 illustrates a diagrammatic representation of a machine in the exemplary form of a computer system, in accordance with one embodiment of the present invention.

### DETAILED DESCRIPTION

Described herein are a system and method for injecting aspect computer code into a computer application to regulate execution of restricted operations. In one embodiment, a computing device receives a request to load a computer application into a memory for execution. The computing device analyzes the computer application to identify one or more join points, and injects aspect computer code into the computer application at the one or more join points to regulate the execution of restricted operations initiated by the computer application based on a restricted operations profile associated with the aspect computer code. The computing device then permits the execution of the computer application, which includes the injected aspect computer code.

In one embodiment, the computer application which is loaded into the memory for execution is a “legacy” application, which has not been modified to adhere to particular security requirements, such as a prohibition against accessing memory of other processes, prohibitions against self-modifying its own executable image, or prohibitions against marking writable memory locations as executable and subsequently causing those writable potions to be executed by the computing device.

In one embodiment, the computing device executes an operating system which has similarly not been modified to enforce particular security requirements, such as those noted above. In this embodiment, a process loader which is interfaced with the operating system performs analysis of the computer application to identify one or more join points within the computer application capable of accepting aspect computer code. These join points may reside at function entry or exit points within machine code which corresponds to the computer application, or in similar block boundaries residing within machine code which corresponds to the computer application.

In one embodiment, the aspect code injected into the executable computer application includes functionality, which is injected into the subject computer application itself, to regulate the execution of restricted operations initiated by the computer application. The aspect code may base these restrictions on, for example, a restricted operations profile associated with the aspect computer code. For example, the restricted operations profile may cause an executing computer application having the injected aspect code to transfer control to a separate computing module which performs a “go” or “no-go” decision on a suspected operation which matches criteria set forth by the restricted operations profile, such as an operation that requests access to memory not associated with the executing computer application, an operation that attempts to mark writable memory locations as executable, and so forth.

In the following description, numerous specific details are set forth such as examples of specific systems, languages, components, etc., in order to provide a thorough understanding of the present invention. It will be apparent, however, to one skilled in the art that these specific details need not be employed to practice the present invention. In other instances, well known materials or methods have not been described in detail in order to avoid unnecessarily obscuring the present invention.

The present invention includes various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

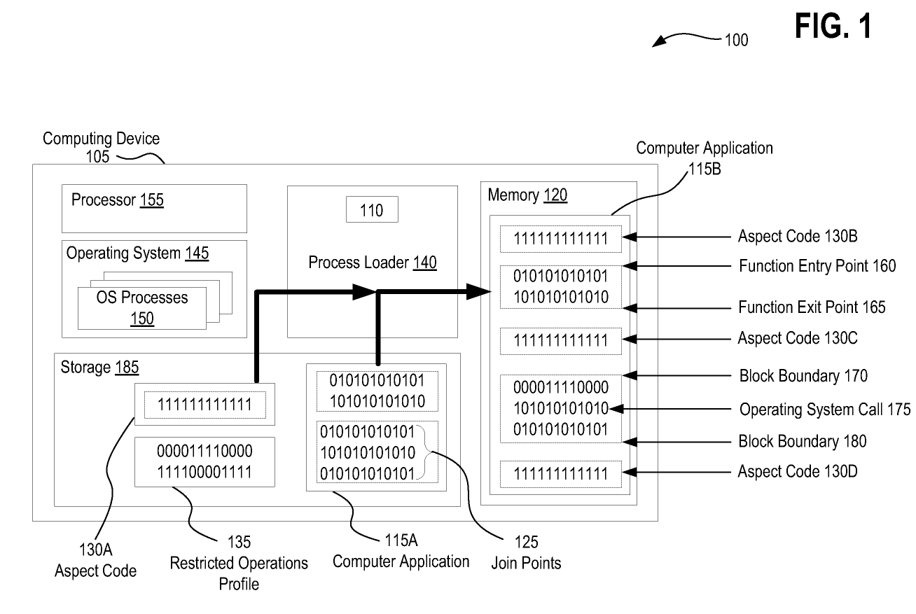

FIG. 1 illustrates an exemplary network architecture 100 in which embodiments of the present invention may operate. With reference to FIG. 1, in one embodiment a computing device receives a request 110 to load a computer application 115A into a memory 120 for execution by the computing device 105.

In this embodiment, the computing device 105 further analyzes the computer application 115 to identify one or more join points 125 in the computer application 115, as will be discussed in greater detail below. In one embodiment, the computing device 105 injects aspect computer code 130 into the computer application 105 at the join points 125. The aspect computer code 130 regulates the execution of restricted operations initiated by the computer application 115 based on a restricted operations profile 135 associated with the aspect computer code 130. In one embodiment, the computing device then executes the computer application 115B having the aspect computer code 130B, 130C, and 130D injected therein, depicted adjacent to the identified join points 125.

Computer application 115A in its original form, aspect code 130, and restricted operations profile 135 are stored within the computing device 105 in storage 185, for example, on a hard disk drive or other type of a file store.

Computing device 105 may be, for example, a desktop computer, a personal computer (PC) (e.g., an x86 based PC), a laptop computer, a mobile phone, a palm-sized computing device, a personal digital assistant (PDA), a computer server, etc.

In one embodiment, the computing device 105 receives a request 110 to load a computer application 115A into a memory 120 at a process loader 140 for an operating system 145 within the computing device 105. In one embodiment, the process loader 140 is responsible for receiving the request and for loading all processes 150 to be executed by the operating system 145 in the computing device 105. In another embodiment, the request 110 is received at an application programming interface (API) which is responsible for handling all load requests on behalf of the operating system and transmitting corresponding process load requests directly into the operating system. In yet another embodiment, the request 110 is received within the operating system 145 itself, at a location where the operating system 145 calls a process loader 140 to load processes 150 on behalf of the operating system 145.

Many modern operation systems utilize a functional module which is separate from the operating system itself to perform loading of processes into the execution environment, and further to perform loading of dynamically linked libraries which are referenced by the computer application being loaded. Where the module is separate from the operating system, a replacement or a modified “process loader” can be implemented which continues to provide the originally intended functionality (e.g., loading processes), but is enhanced in such a way as to perform the methodologies discussed herein. In particular, the process loader can be enhanced to perform the analysis of computer applications 115A requested for loading and then the injection of aspect code 130 into those computer applications, as depicted by computer application 115B. Alternatively, the enhanced process loader can initiate the execution of sub-modules or hardware modules to perform these functions.

The process loader to be replaced or modified depends upon the operating system in question, and may include, for example, modifications to the “1d.so” module in Linux variants or modifications to the “StartProcess” and “StartProcessX” API functions in Windows™ variants. Apple Macintosh™ variants have a process loader which operates similarly to the “1d.so” module in Linux. Other modern operating environments can also be structured in a similar manner.

In some computing environments where a process loader is responsible only for loading processes that refer to dynamically linked libraries, the process isolation protections can be provided for computer applications 115 that do not perform dynamic loading. For example, in Linux, a single binary handler may be modified to refer the requested computer application 115A for loading to the process loader 140 having the functionality to inject the aspect code 130, or the binary handler may be modified to perform the necessary functionality itself. In Windows™ variants, all API calls to load an executable can be monitored and then referred to an appropriate process loader 140, or alternatively, each of the entry points into the dynamically linked libraries could be substituted with a dynamic link library entry point that refers to, or performs the appropriate aspect code injection functionality.

In one embodiment, the computer application 115A is made up of an executable image of machine computer code. Machine code or executable images of machine code may be derived from higher level programming languages through the process of compilation of the higher level computer programming instructions into machine code which is specialized for a particular computing hardware platform and computer processing unit or processor, such as processor 155.

In one embodiment, the executable image of machine computer code may correspond to a compiled computer code interpreter, rather than directly to a computer program itself. For example, computer code interpreters, such as a Java™ Virtual Machine (JVM), or a Shell script interpreter (e.g., a PERL script code interpreter or similar interpreters for Ruby, PHP, TCL, Fourth, etc.).

Compiled computer code interpreters accept computer code, scripts, byte code or higher level computer instructions which are not yet suited for execution by a particular hardware platform or corresponding computer processor unit 155. The compiled code interpreters themselves, however, may be made up of machine code which can be executed directly by particular hardware platform. In such an embodiment, rather than injecting aspect code 130 into the byte code or scripts which are later processed by the compiled computer code interpreter, the aspect code 130 may be injected at appropriate join points 125 identified by the process loader 140 within the compiled computer code interpreter or computer application 115A itself.

Regardless of whether the computer application 115 is a compiled computer application or a compiled computer code interpreter, aspect code 130 injected at join points 125 within the machine code may be used to regulate suspect operations of the computer application 115.

As discussed above, in one embodiment, the computing device 105 analyzes the computer application 115 to identify join points 125 within the executable image of machine computer code. For example, the computing device 105 may identify join points 125 located at function entry points 160 in the executable image of machine computer code, at function exit points 165 in the executable image of machine computer code, at the beginning of block boundaries 170 in the executable image of machine computer code, at the end of block boundaries 180 in the executable image of machine computer code, and at operating system calls 175 within the executable image of machine computer code.

Utilizing aspect-oriented programming methodologies, an aspect weaver is used to inject or “weave” aspect code 130 into the computer application 115 at the identified join points 125. The injected aspect code 130 is a “cross-cutting concern,” as it embodies functionality or a “concern” that cuts across multiple abstractions of the computer application 115. Indeed, the computer application 115 may be unaware of and unconcerned with the implications or functionality of the aspect code 130, as the aspect code 130 was very likely not considered at the time the computer application 115 was written. Nevertheless, the aspect code 130 is a “cross-cutting concern” because it provides process containment and allows for process isolation by triggering various security mechanisms, such as restrictions on suspect operations initiated by the computer application 115.

Generally speaking, identified “join points,” such as join points 125, are locations within the computer application 115, or the machine code corresponding to the computer application, where additional functionality can be introduced without disrupting the stability of the computer application itself. Join points 125 can be introduced before, after, or around a block of code, around, before, or after a function, a method, or a block boundary. The join points must be addressable by the computer application 115 to be triggered appropriately, and then return control back to the original computer application's 115 programmed code, after performing the logic within the aspect code 130, or the particular cross-cutting concern, such as performing “go” and “no-go” decisions or generally implementing restrictions pertaining to computer operations initiated by the computer application 115.

In one embodiment, the aspect code 130 which enforces restrictions on computer operations initiated by the computer application 115 are injected or woven into the original program code before a subroutine of the original computer application following an identified join point.

Many modern operating systems provide native functionality to restrict the types of computer operations discussed herein, such as prohibiting the marking of writable memory as executable, and prohibiting the loading of additional dynamically linked libraries after an initial load phase. However, this functionality, while useful, cannot be enforced against legacy and unmodified computer applications 115 using traditional techniques, leaving other processes executing within the same operating environment potentially subject to maliciously performed operations by a computer application 115 that has computer bugs, malicious code, or a virus embedded within it.

Older and less sophisticated operating systems, such as MSDOS can similarly implement process isolation by identifying operating system calls as join points, in which the aspect code 130 monitors for a known set of execution instructions which correspond with the suspect operations to be restricted. For example, the aspect code 130 may contain functionality to watch for a “cd80” operating system call in MSDOS, which is presumed to be “suspect,” and may then be reviewed in further detail to determine an appropriate action, if any. Other codes may obviously be monitored as well, or different codes may be monitored within different operating environments. Once particular operating system calls are identified for a particular operating system, those codes may be used as a basis to trap potentially suspect computer operations for further processing and review.

In one embodiment, injecting the aspect computer code 130 into the computer application 115 at the one or more join points 125 includes loading the computer application 115A into a memory 120 under the control of the process loader 140 and prior to allowing execution of the computer application 115B, modifying the executable image of the computer application 115B loaded in memory by “weaving” or injecting the necessary cross-cutting concerns (e.g., “go” and “no-go” decision determinations of suspect operations) into the machine code of the computer application 115B in the memory 120. Once the aspect code 130 has been weaved into the target computer application 115, the process loader may then release the computer application for execution, thus allowing the computer application to perform its intended task.

With computer code interpreters in particular, such as virtual machines (e.g., the Java™ Virtual Machine), system calls may represent the best join points, as the system calls represent a location within the computer application where a suspect operation is more likely to be performed, and may be an ideal place to trap the system call for additional review and appropriate action, such as restrictions on the requested system call. While the interpreted code may be executed generally within the computer code interpreter, it is the system call functions and methods extending from the computer code interpreter which are likely to attempt suspect operations that could violate established security mechanisms for the operating environment.

When the computer application 115B is released for execution, or simply begins executing within the computing device 105, it may have no internal knowledge whatsoever that it has been modified from its original state in any way. Indeed, regardless of whether the computer application 115B is made aware of any change, no such knowledge or internal awareness is required. The computer application 115 will simply execute as originally intended, and upon encountering aspect code 130 which has been injected at an appropriate join point 125, the computer application will simply execute the injected aspect code 130, or transfer control or operation to another function, possibly a remote program or remote function, which is referenced by the aspect code 130 injected into the computer application 115B.

The functionality of the injected aspect code 130 may be based, at least in part, on a restricted operations profile 135. The restricted operations profile 135 may contain a listing of operations which are generally allowable, or “suspect” operations which may require further analysis, special exceptions, special pre-approval, or potentially an outright prohibition against the suspect operations. For example, some operations may be prohibited by default within the restricted operations profile 135, and thus be restricted by the aspect computer code 130 when such operations are initiated by the computer application 115.

Generally allowable operations may include operation requests such as attempting to read from memory allocated to the computer program, attempting to modify writable memory allocated to the computer program, attempting to write information to a database or a data store properly registered with the computing device 105 (e.g., via a file system or database interface), or depending on the computing device 105, requesting additional memory allocations.

Other operations which may be initiated by the computer application may be inherently suspect, or restricted by default, without special exceptions, considerations, or pre-approvals, and as such, the aspect code 130 injected into the computer program 130 may cause the operations to be restricted when initiated by the computer application 115. For example, suspect operations or restricted operations may include requests to load executable code after an initial process load associated with the computer application, requests to access memory locations which are not allocated to the computer application, requests to make executable memory locations writable, requests to make writable memory locations executable, requests to commit modifications to dynamically linked libraries or dynamically linked library modules, and requests to self-modify the executing computer application 115B (e.g., any attempt to modify the computer application's 115B own computer code executing from memory 120).

The above list of restricted, suspect, or prohibited operations are merely an example of some operations which may expose the computing device 105, its executing processes 150, operating system 145, and computer resources in general to potentially malicious code or even negligently written code that inappropriately interferes with other processes 150 executing within the same computing environment. For example, the prohibition against marking writable memory locations as executable, may be used to prevent a computer application from writing malicious code into memory, and then causing that code to be executed, either by the computer application 115 itself, or by other processes 150 within the computing device or by the operating system 145 of the computing device.

In one embodiment, the aspect computer code 130 used to regulate the execution of restricted operations initiated by the computer application 115 may perform a “go” or “no-go” decision as to whether to allow the requested operation after a comparison of the operation requested by the computer application 115 at the join points 125 against the restricted operations profile 135.

The aspect code 130 may cause any one of several events to be performed based on the restricted operations profile 135, such as allowing the execution of a computer operation requested by the computer application 115 without modification, or allowing execution of the computer operation requested by the computer application as modified by the aspect computer code 130 (for example, the aspect code 130 may modify the requested operation to make it comply with security requirements, to remove any potential for malicious use, etc.).

The aspect code 130 may also outright prevent the execution of the requested operation by silently failing the computer operation requested by the computer application. Where the aspect code 130 silently fails a requested operation, it prevents the execution of the computer operation requested without notifying the computer application, leaving the requesting computer application without any confirmation, failure message, acknowledgement, or other result. The aspect code 130 may similarly perform a silent pass of the requested computer operation, where aspect code 130 allows the execution of the computer operation requested, but as above, does not notify the computer application that the operation was allowed or even performed.

The aspect code 130 may terminate the computer operation requested by the computer application, thus preventing the execution of the computer operation requested, and subsequently notify the computer application 115 of the termination, for example, by returning an error code which indicates that the requested operation was terminated by the operating system or terminated due to a security restriction, or other appropriate notification.

The aspect code 130 may also perform a false pass in response to the requested computer operation, where the aspect code 130 prevents the execution of the computer operation requested, but makes an affirmative acknowledgement to the computer application that the requested operation was completed successfully, or executed correctly, for example, via a successful execution message which is returned to the computer application (e.g., a return code of “0” in many operating environments).

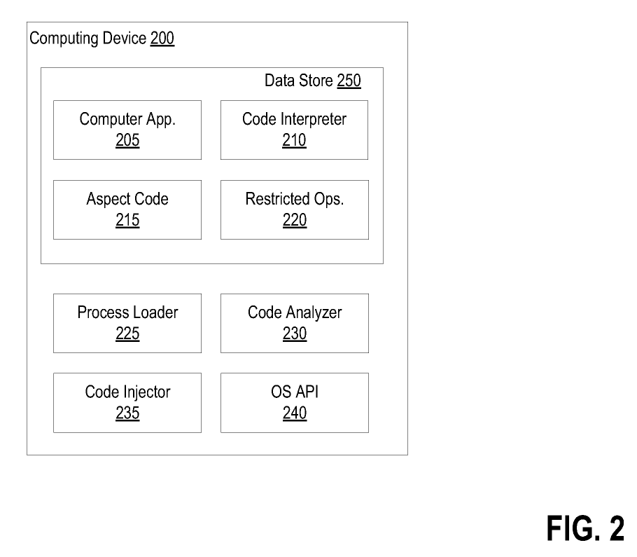

FIG. 2 is a diagrammatic representation of a computing device 200 in accordance with one embodiment of the present invention. Computing device 200 includes a data store 250 which may store computer application 205 which performs functionality within the computing device, and which aspect code 215 may be weaved or injected into by a process loader 225. Similarly, data store 250 includes code interpreter 210, which itself interprets byte code or scripts rather than performing a specific programming function (aside from code interpretation), and which aspect code 215 is similarly woven into. Data store 250 also includes aspect code 215 which is woven or injected into computer application 205 and code interpreter 210. Data store 250 further includes restricted operations 220, which may be in the form of a restricted operations profile, or a list of restricted operations that, when compared or referenced by executing aspect code 215, can allow or restrict such operations.

Computing device 200 further includes process loader 225 which receives requests on behalf of the computing device 200 or an operating system executing within the computing device to load processes. The process loader 225 may rely upon code analyzer 230 to analyze computer application 205 or code interpreter 210 to identify appropriate join points into which the aspect code 215 may be injected, including its cross-cutting concern functionality to restrict or control computer operations requested by the computer application and the code interpreter. Code injector 235 within computing device 200 performs the weaving or injection of the aspect code 215. Operating System Application Programming Interface (OS API) provides an alternative interface into an operating system of the computing device 200 by which processes may be loaded, and by which the code analyzer 230 and the code injector 235 may be caused to identify joint points in the computer application 205 and code interpreter 210 and inject or weave the aspect code 215.

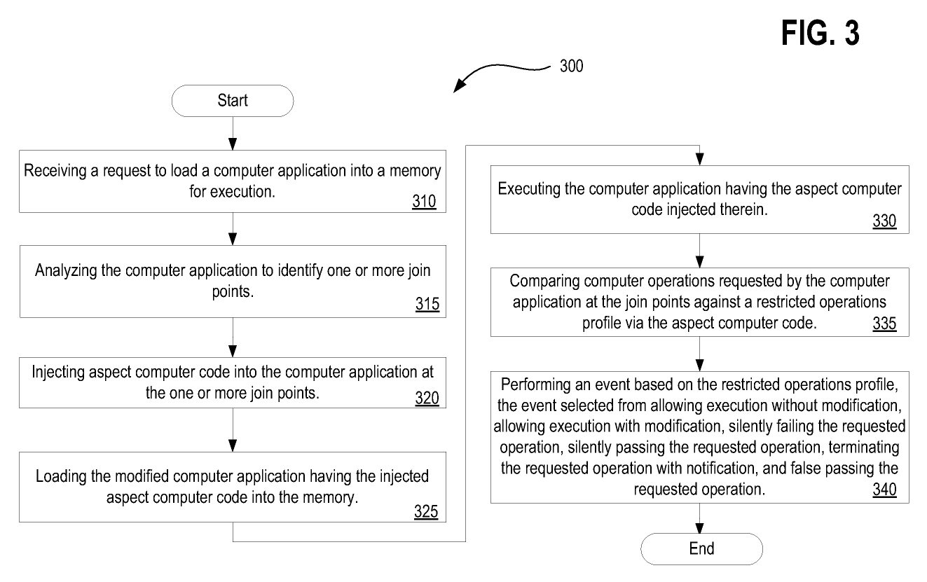

FIG. 3 is a flow diagram illustrating a method 300 for injecting aspect computer code into a computer application to regulate execution of restricted operations, in accordance with one embodiment of the present invention. Method 300 may be performed by processing logic that may include hardware (e.g., circuitry, dedicated logic, programmable logic, microcode, etc.), software (e.g., instructions run on a processing device to perform hardware simulation), or a combination thereof. In one embodiment, method 300 is performed by a computing device, such as computing device 105 of FIG. 1.

Referring to FIG. 3, method 300 begins with processing logic in the computing device to receive a request to load a computer application into a memory for execution (block 310). At block 315, processing logic analyzes the computer application to identify one or more join points. Such join points may be at entry or exits from functions, at the beginning or ending of block boundaries in machine code corresponding to the computer application, or at operating system calls within the machine code, for example, operating system calls that correspond to marking writable memory as executable, and so forth.

At block 320, processing logic injects aspect computer code into the computer application at the one or more join points identified. Once injected (e.g., once the cross-cutting concern aspect code is woven into the computer application), the computer application will execute the aspect code as though it is its original code, and the injected aspect code can cause computer operations requested by the computer application to be regulated in accordance with a list or profile of restricted operations which is associated with the aspect code or referenced by the aspect code injected.

At block 325, processing logic loads the modified computer application having the injected aspect computer code into the memory. At block 330, processing logic executes the computer application having the aspect computer code injected therein. At block 335, processing logic compares the computer operations requested by the computer application at the join points against a restricted operations profile using the aspect computer code injected into the computer application.

At block 340, the processing logic performs one of several events, based on the restricted operations profile. Events to be performed may include allowing execution without modification, allowing execution with modification, silently failing the requested operation, silently passing the requested operation, terminating the requested operation with notification, and false passing the requested operation.

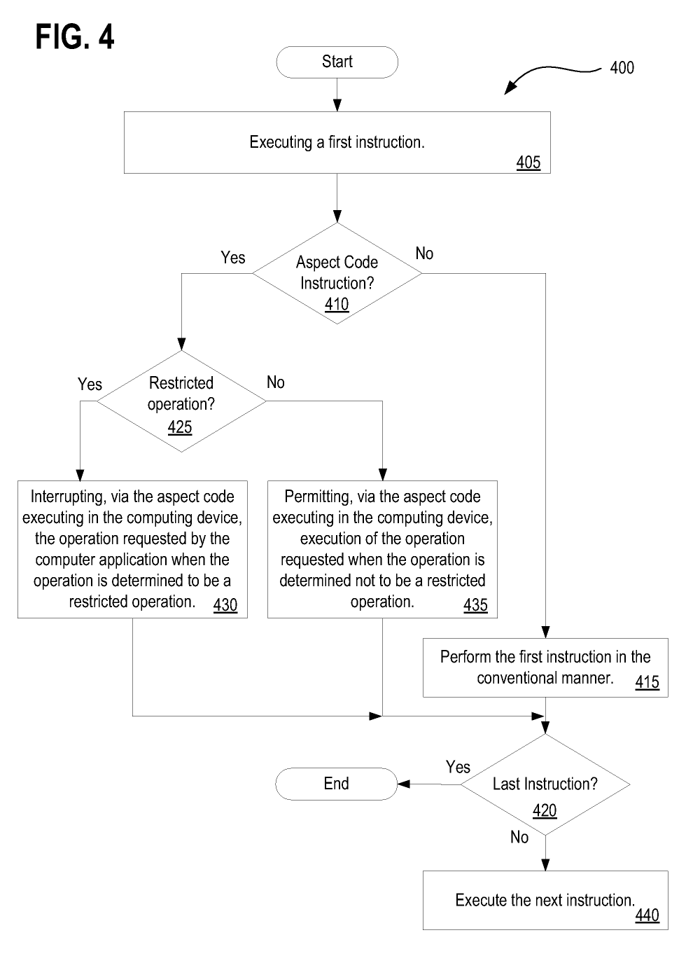

FIG. 4 is a flow diagram illustrating a method 400 for executing a computer application having aspect computer code injected therein, in accordance with one embodiment of the present invention. Method 400 may be performed by processing logic that may include hardware (e.g., circuitry, dedicated logic, programmable logic, microcode, etc.), software (e.g., instructions run on a processing device to perform hardware simulation), or a combination thereof. In one embodiment, method 400 is performed by a computing device, such as computing device 105 of FIG. 1.

Referring to FIG. 4, method 400 begins with processing logic in the computing device to execute, in the computing device, a first instruction (block 405). At decision block 410, if the instruction is non-aspect code, then method 400 continues to block 415, where processing logic in the computing device performs the first instruction in the conventional manner. Alternatively, at decision block 410, when the instruction being executed is aspect code, method 400 continues to decision block 425 to determine whether the instruction is a restricted operation.

Referring to decision block 425, when an operation is determined to be a restricted operation, processing logic interrupts the operation requested by the computer application (block 430). When an operation is determined not to be a restricted operation, processing logic permits execution of the operation requested by the computer application (block 435).

Method 400 proceeds from blocks 415, 430, and 435 to decision block 420, where a determination is made whether the instruction executed is the last instruction of the computer application. When the instruction is the last instruction, method 400 ends. When the instruction is not the last instruction, method 400 proceeds to block 440, where processing logic executes the next instruction and method 400 is repeated.

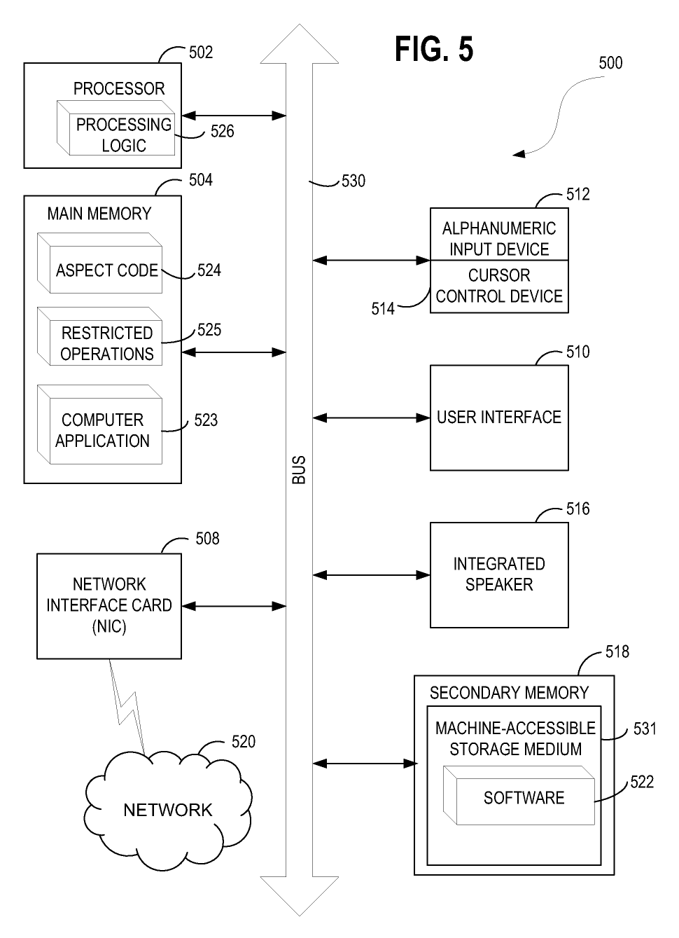

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), etc.), and a secondary memory 518 (e.g., a data storage device), which communicate with each other via a bus 530. Main memory 504 includes aspect code 524 to be woven or injected into computer applications as a cross-cutting concern to control or regulate a list of restricted operations 525, which are also stored within the main memory 504. Computer application 523 is similarly stored within main memory 504, which may be an unmodified and unsupported legacy application, a currently supported utility application, or a computer code interpreter, such as a “virtual machine,” which, upon being loaded and injected with the aspect computer code 524, will trigger the aspect code at the employed join points to regulate computer operations which are initiated by the computer application 523, in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and steps discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., a speaker).

The secondary memory 518 may include a machine-readable storage medium (or more specifically a computer-readable storage medium) 531 on which is stored one or more sets of instructions (e.g., software 522) embodying any one or more of the methodologies or functions described herein. The software 522 may also reside, completely or at least partially, within the main memory 504 and/or within the processing device 502 during execution thereof by the computer system 500, the main memory 504 and the processing device 502 also constituting machine-readable storage media. The software 522 may further be transmitted or received over a network 520 via the network interface device 508.

While the machine-readable storage medium 531 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
receiving, at a computing device, a request to load a computer application into a memory of the computing device for execution;
analyzing, by the computing device, the computer application to identify one or more join points;
injecting, by the computing device, aspect computer code into the computer application at the one or more join points, the aspect computer code to regulate the execution of restricted operations initiated by the computer application based on a restricted operations profile associated with the aspect computer code; and
executing the computer application having the aspect computer code injected therein.

2. The method of claim 1, wherein receiving the request to load a computer application into the memory for execution comprises one of:
receiving the request at a process loader for an operating system, wherein the process loader loads all processes to be executed by the operating system;
receiving the request at an application programming interface (API), wherein the API to receive all load requests on behalf of the operating system and transmit corresponding process load requests to the operating system; and
receiving the request within the operating system where the operating system calls the process loader to load processes on behalf of the operating system.

3. The method of claim 1, wherein the computer application comprises an executable image of machine computer code.

4. The method of claim 3, where analyzing the computer application to identify the one or more join points comprises analyzing the executable image of machine computer code in the memory to identify one or more of:
function entry points in the executable image of machine computer code;
function exit points in the executable image of machine computer code;
block boundary entry points in the executable image of machine computer code;
block boundary exit points in the executable image of machine computer code; and operating system calls in the executable image of machine computer code.

5. The method of claim 3, wherein the executable image of machine computer code corresponds to one of:
a compiled computer program; and
a compiled computer code interpreter.

6. The method of claim 4, wherein:
the aspect computer code comprises executable machine computer code; and wherein injecting the aspect computer code into the computer application at the one or more join points comprises injecting the executable machine computer code into the executable image of machine computer code in the memory.

7. The method of claim 1, wherein the restricted operations profile comprises a listing of operations which are restricted by the aspect computer code when initiated by the computer application, wherein the listing of operations is selected from the group comprising:
requests to load executable code after an initial process load associated with the computer application;
requests to access memory locations which are not allocated to the computer application;
requests to make executable memory locations writable;
requests to make writable memory locations executable;
requests to commit modifications to dynamically linked libraries; and
requests to self-modify the executing computer application.

8. The method of claim 1, wherein the aspect computer code to regulate the execution of restricted operations initiated by the computer application comprises:
the aspect computer code to compare computer operations requested by the computer application at the join points against the restricted operations profile, and
perform one of the following events based on the restricted operations profile:
allow execution of a computer operation requested by the computer application without modification;
allow execution of the computer operation requested by the computer application as modified by the aspect computer code;
silently fail the computer operation requested by the computer application, wherein the aspect code prevents the execution of the computer operation requested without notifying the computer application;
silently pass the computer operation requested by the computer application, wherein the aspect code allows the execution of the computer operation requested without notifying the computer application;
terminate the computer operation requested by the computer application, wherein the aspect code prevents the execution of the computer operation requested and notifies the computer application of the termination; and
false pass the computer operation requested by the computer application, wherein the aspect code prevents the execution of the computer operation requested and returns a successful execution message to the computer application.

9. A computer-readable medium, having instructions stored thereon that, when executed by a processor, perform a method comprising:
receiving a request to load a computer application into a memory of a computing device for execution;
analyzing the computer application to identify one or more join points;
injecting aspect computer code into the computer application at the one or more join points, the aspect computer code to regulate the execution of restricted operations initiated by the computer application based on a restricted operations profile associated with the aspect computer code; and
executing the computer application having the aspect computer code injected therein.

10. The computer-readable medium of claim 9, wherein the computer application comprises an executable image of machine computer code, and wherein analyzing the computer application to identify the one or more join points comprises analyzing the executable image of machine computer code in the memory to identify one or more of:
function entry points in the executable image of machine computer code;
function exit points in the executable image of machine computer code;
block boundary entry points in the executable image of machine computer code;
block boundary exit points in the executable image of machine computer code; and
operating system calls in the executable image of machine computer code.

11. The computer-readable medium of claim 9, wherein the aspect computer code comprises executable machine computer code; and wherein
injecting the aspect computer code into the computer application at the one or more join points comprises injecting the executable machine computer code into the executable image of machine computer code in the memory.

12. The computer-readable medium of claim 9, wherein the restricted operations profile comprises a listing of operations which are restricted by the aspect computer code when initiated by the computer application, wherein the listing of operations is selected from the group comprising:
requests to load executable code after an initial process load associated with the computer application;
requests to access memory locations which are not allocated to the computer application;
requests to make executable memory locations writable;
requests to make writable memory locations executable;
requests to commit modifications to dynamically linked libraries; and
requests to self-modify the executing computer application.

13. A computing device comprising:
a memory coupled with a processor loader to receive a request to load a computer application into the memory for execution;
a code analyzer coupled with a processor and the memory to analyze the computer application and identify one or more join points;
a code injector coupled with the processor and the memory to inject aspect computer code into the computer application at the one or more join points, the aspect computer code to regulate the execution of restricted operations initiated by the computer application based on a restricted operations profile associated with the aspect computer code; and
the processor to execute the computer application having the aspect computer code injected therein.

14. The computing device of claim 13, wherein the code analyzer to analyze the computer application and identify one or more join points comprises the code analyzer to analyze the computer application in the memory for one or more of:
a function entry point in the computer application;
a function exit points in the computer application;
a block boundary entry points in the computer application;
a block boundary exit points in the computer application; and
an operating system calls in the computer application.

15. The computing device of claim 13, wherein:
the computer application comprises an executable image of machine computer code;
the aspect computer code comprises executable machine computer code; and wherein
the code injector to inject the aspect computer code into the computer application at the one or more join points comprises the code injector to inject the executable machine code into the executable image of machine computer code in the memory.

16. The computing device of claim 13, wherein the aspect computer code to regulate the execution of restricted operations initiated by the computer application comprises:
the aspect computer code, when executed by the processor, to compare computer operations requested by the computer application at the join points against the restricted operations profile, and perform one of the following events based on the restricted operations profile:
allow execution of a computer operation requested by the computer application without modification;
allow execution of the computer operation requested by the computer application as modified by the aspect computer code;
silently fail the computer operation requested by the computer application, wherein the aspect code prevents the execution of the computer operation requested without notifying the computer application;
silently pass the computer operation requested by the computer application, wherein the aspect code allows the execution of the computer operation requested without notifying the computer application;
terminate the computer operation requested by the computer application, wherein the aspect code prevents the execution of the computer operation requested and notifies the computer application of the termination; and
false pass the computer operation requested by the computer application, wherein the aspect code prevents the execution of the computer operation requested and returns a successful execution message to the computer application.

17. A computer-implemented method comprising:
executing, in a computing device, a computer application having aspect code injected therein at one or more join points, the aspect computer code to regulate the execution of restricted operations initiated by the computer application based on a restricted operations profile associated with the aspect computer code;
receiving, in the computing device, a request from the computer application to perform an operation;
determining, via the aspect code executing in the computing device, whether the operation requested by the computer application is a restricted operation based on the restricted operations profile; and
interrupting, via the aspect code executing in the computing device, the operation requested by the computer application when the operation is determined to be a restricted operation or permitting execution of the operation requested when the operation is determined not to be a restricted operation.

18. The computer-implemented method of claim 17, wherein interrupting, via the aspect code executing in the computing device, the operation requested by the computer application when the operation is determined to be a restricted operation comprises the computer application performing one or more of the following events:
terminating requests initiated by the computer application to load executable code after an initial process load associated with the computer application;
terminating requests initiated by the computer application to access memory locations which are not allocated to the computer application;
terminating requests initiated by the computer application to make executable memory locations writable;
terminating requests initiated by the computer application to make writable memory locations executable;
terminating requests initiated by the computer application to commit modifications to dynamically linked libraries; and
terminating requests initiated by the computer application to self-modify the executing computer application.

19. The computer-implemented method of claim 18, wherein the computer application executing in the computing device further performs one or more events selected from the group comprising:
returning an error code to the computer application indicating that the operation requested by the computer application was terminated after terminating the request initiated by the computer application; and
returning a false pass to the computer application indicating that the operation requested by the computer application was successfully performed after terminating the request initiated by the computer application.

20. The computer-implemented of claim 17, wherein the computer application having the aspect code injected therein comprises one of the following:
a computer program compiled into an executable image of machine computer code having aspect code in machine code format injected at the one or more join points; and
a computer code interpreter compiled into the executable image of machine computer code having aspect code in machine code format injected at the one or more join points.
